(19) United States
(12) Patent Application Publication
(10) Pub. No.: US 2011/0215929 A1
(43) Pub. Date: Sep. 8, 2011

(54) SYSTEM FOR TESTING REUSABLE ELECTRONIC ARTICLE SURVEILLANCE TAGS AND METHOD THEREFOR

(75) Inventors: John F. BOHN, Aguadilla, PR (US); Paul Griffiths, Boca Raton, FL (US); Luis Angel ARROYO, Anasco, PR (US); Carlos Javier VILLANUEVA, Aguadilla, PR (US); Benjamin NIEVES, Quebradillas, PR (US); Eugenio MARCANO, Aguadilla, PR (US); Daniel R. RODRIGUEZ, Cabo Rojo, PR (US); Luis G. CANABAL, Arecibo, PR (US); Francisco De JESUS, Aguada, PR (US); Héctor L. CRUZ, Cabo Rojo, PR (US); Raymond RIOS, Aguadilla, PR (US); Julio C. GONZALEZ, Aguada, PR (US)

(73) Assignee: SENSORMATIC ELECTRONICS, LLC, Boca Raton, FL (US)

(21) Appl. No.: 13/039,928

(22) Filed: Mar. 3, 2011

Related U.S. Application Data
(60) Provisional application No. 61/339,527, filed on Mar. 5, 2010.

(51) Int. Cl. G08B 13/14

(52) U.S. Cl. 340/572.3; 340/572.1

(57) ABSTRACT

A system and method for automatically sorting, cleaning, testing and counting reusable visible source tags (VSTs) and for detecting and rejecting tags that are not functioning within predetermined parameters. The system includes a first sub-system that stores and feeds the VSTs to a vibratory bowl where they are initialized. A second sub-system transfers the tags from the vibratory bowl and sorts the tags assuring the tags are reusable rather than disposable tags. A third sub-system tests the reusable tags to assure compliance with select parameters such as frequency and amplitude. If the reusable tags comply with the parameters then they are deemed activatable. The system may also automatically sort and count the accepted and rejected tags. The system disclosed herein is capable of testing VSTs at a high speeds, e.g., up to 150 units per minute, with the required quality level and reliability.

### CROSS-REFERENCE TO RELATED APPLICATION

This application is related to and claims priority to U.S. Provisional Patent Application Ser. No. 61/339,527, filed Mar. 5, 2010, entitled Apparatus for Testing Reusable Electronic Article Surveillance Tags and System and Method Therefor, the entirety of which is incorporated herein by reference.

### STATEMENT REGARDING FEDERALLY SPONSORED RESEARCH OR DEVELOPMENT

n/a

### FIELD OF THE INVENTION

The present invention relates generally to electronic article surveillance (“EAS”) tags, and more specifically to a system and method for testing reusable EAS tags.

### BACKGROUND OF THE INVENTION

Electronic article surveillance (“EAS”) systems are generally known in the art for the prevention or deterrence of unauthorized removal of articles from a controlled area. In a typical EAS system, EAS markers (tags or labels) are designed to interact with an electromagnetic field located at the exits of the controlled area, such as a retail store. These EAS markers are attached to the articles to be protected. If an EAS tag is brought into the electromagnetic field or “interrogation zone,” the presence of the tag is detected and appropriate action is taken, such as generating an alarm. For authorized removal of the article, the EAS tag can be deactivated, removed or passed around the electromagnetic field to prevent detection by the EAS system.

EAS systems typically employ either reusable EAS tags or disposable EAS tags or labels to monitor articles to prevent shoplifting and unauthorized removal of articles from the store. The reusable EAS tags are normally removed from the articles before the customer exits the store. Once removed from the article, it is possible to reuse the tag if it is properly reactivated. However, if the tags are to be applied to articles at the point of manufacturing or distribution (i.e. “source-tagged”), the tags must first be returned to the place of application, and each tag must be cleaned and tested prior to re-use to ensure that it can be reactivated. At the present time, there is no automated process available for testing reusable EAS tags which has the required processing speed and testing capability for testing recyclable visible source tags (VSTs).

Therefore, what is needed is an efficient system and method for determining if EAS tags are reusable and for testing the reusable EAS tags to determine if they are capable of functioning as active VSTs.

### SUMMARY OF THE INVENTION

The present invention advantageously provides a method and system for testing EAS tags, particularly recyclable visible source tags (VSTs).

In one aspect of the invention, a system for testing reusable electronic article surveillance (EAS) tags is provided. The system includes a feeder for receiving previously used EAS tags, a sorter receiving the previously used EAS tags from the feeder, the sorter determining if the previously used EAS tags are reusable tags, and a cleaning and testing station receiving the reusable EAS tags from the sorter, the testing station determining if the reusable EAS tags are functioning within predetermined operational parameters.

In another aspect of the invention, a method for testing reusable electronic article surveillance (EAS) tags is provided. The method includes separating, at a sorter, reusable EAS tags from disposable EAS tags, using demagnetizer and magnetizer to re-activate reusable EAS tags, and automatically determining if the reusable EAS tags are functioning within predetermined operational parameters.

In still another aspect of the invention, an automated system for determining the presence of operable, reusable electronic article surveillance (EAS) tags from among used EAS tags, is provided. The system includes a feeder for receiving previously used EAS tags, a sorter receiving the previously used EAS tags from the feeder, the sorter determining if the previously used EAS tags are reusable tags, the sorter including at least one demagnetizer element and at least one magnetizer element for activating the reusable EAS tags, a testing station having at least one antenna for receiving responsive signals from the reusable EAS tags, the responsive signals being used to determine if the reusable EAS tags are functioning within predetermined operational parameters, and a conveyor system for spacing the reusable tags and transporting the spaced reusable tags from the sorter to the testing station.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a side view of an exemplary VST sorting and testing system constructed in accordance with the principles of the present invention;

FIG. 2 is a top view of the VST sorting and testing system of FIG. 1;

FIG. 3 is a block diagram of the VST sorting and testing system of FIG. 1;

FIG. 4 is a top view of a pair of magnetizers used in accordance with the principles of the present invention;

FIG. 5 is a top view of a pair of demagnetizers used in accordance with the principles of the present invention;

FIG. 6 is a block diagram of the control box used in the VST sorting and testing system of the present invention;

FIG. 7 is a perspective view of the rail assembly used in the VST sorting and testing system of the present invention;

FIG. 8 is an exploded view of the conveyor and antenna assembly portion of the VST sorting and testing system of FIG. 1; and

FIG. 9 is a flowchart showing the steps performed by an exemplary VST sorting and testing system constructed in accordance with the principles of the present invention.

### DETAILED DESCRIPTION OF THE INVENTION

Before describing in detail exemplary embodiments that are in accordance with the present invention, it is noted that the embodiments reside primarily in combinations of apparatus components and processing steps related to implementing a system and method for automatically sorting, testing and counting reusable visible source tags (VSTs) and for detecting and rejecting tags that are not functioning within predetermined operational parameters. Accordingly, the system and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

As used herein, relational terms, such as “first” and “second,” “top” and “bottom,” and the like, may be used solely to distinguish one entity or element from another entity or element without necessarily requiring or implying any physical or logical relationship or order between such entities or elements.

One embodiment of the present invention advantageously provides a method and system for sorting, testing and counting reusable visible source tags (referred to interchangeably as “VSTs” or “tags”) and also for detecting and rejecting tags which are not functioning within predetermined parameters. The system of the present invention includes a first sub-system that stores and feeds the VSTs to a vibratory bowl, a second sub-system that moves and sorts the tags assuring the tags are reusable rather than disposable tags, and a third sub-system that tests the reusable tags to assure compliance with select operating parameters such as frequency and amplitude. The system may also automatically sort and count the accepted and rejected tags. The system disclosed herein is capable of testing VSTs at a high speeds, e.g., up to 150 units per minute.

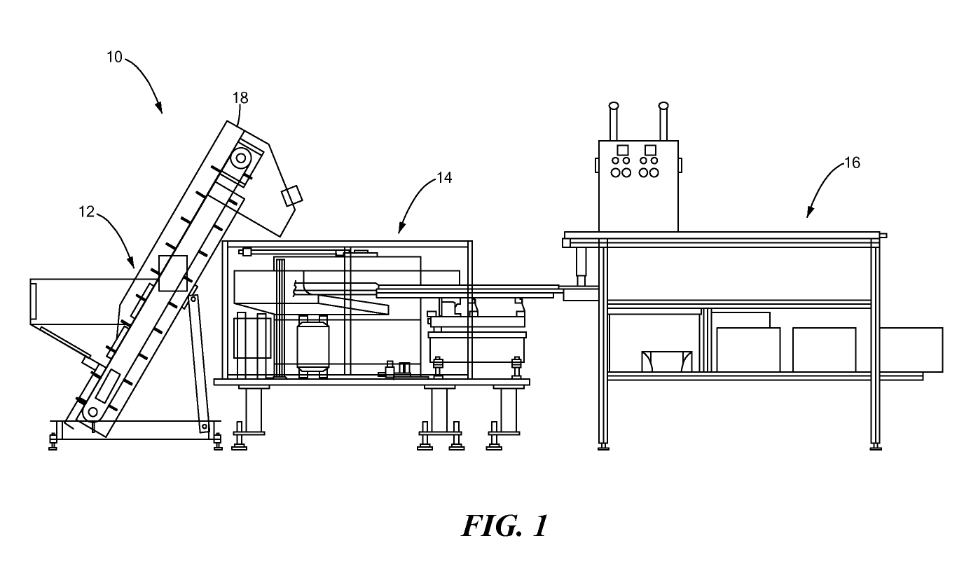

Referring now to the drawing figures in which like reference designators refer to like elements, there is shown in FIG. 1 a VST sorting and testing system 10 that includes a feeder subsystem 12, a sorting subsystem 14 and a testing subsystem 16. Feeder subsystem 12 includes a hopper or elevator 18, which receives previously used tags. Elevator 18 feeds the tags into a vibratory bowl which is part of sorting subsystem 14, where the tags are sorted to differentiate reusable VSTs from disposable VSTs, other EAS tag families and other non-tag objects including tack assemblies and foreign objects. Sorting subsystem 14 also properly orients the tags before they are deposited on one or more conveyors. The tags are ultimately fed into a conveyor system by a singulator mechanism, although other feeding systems may be used. One or more sorting stations with the testing subsystem provide continuous machine operation.

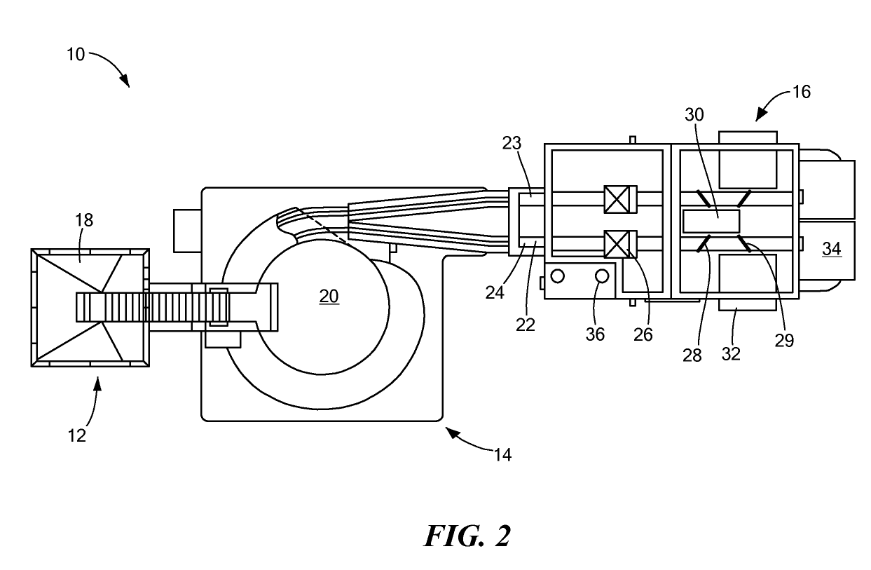

VSTs that are not determined to be reusable, e.g., disposable VSTs, tack assemblies, etc. are directed into separate bins and may be automatically counted. Foreign objects and other tags stay inside the vibratory bowl (shown in FIG. 2) and may be manually removed. Reusable VSTs are delivered via the conveyors to a testing subsystem 16, which includes testing antennas that determine if the reusable tags comply with various parameters such as frequency and amplitude, and if so, are considered electrically operable. The accepted VSTs are sorted, counted and bagged or boxed while the non-compliant, defective tags are directed toward “reject” bins. In one embodiment, a cleaning system that cleans the reusable tags using, for example, in-line rotary dry brushes, may be added to system 10.

FIG. 2 represents a top view of system 10 of the present invention. Elevator 18, which is part of feeder subsystem 12 feeds tags into vibratory bowl 20, which is part of sorting subsystem 14. Tags coming out of vibratory bowl 20 are placed on one or more inline tracks or conveyors 22 and 23. Conveyors 22 and 23 carry tags deemed reusable tags toward feed gate 24 and testing subsystem 16. Testing subsystem 16 includes one or more test antennas 26 (discussed in greater detail below), which transmit test signals to the tags as they pass along conveyor 22. Fail gate 28 directs tags that do not pass testing by antennas 26 into one or more reject bins 30. Pass gate 29 direct tags that pass testing toward accept bins 32 and 34. The invention is not limited to a specific number or placement of reject or accept bins. Indicators 36 can be visual or audible indicators, indicating the status of accept bins 32 and 34 and the status of other system components. For example, if visual indicators 36 are utilized and both bins 32, 34 are full, a red light might indicate the occurrence of this event. A green light can indicate that the bins are in the process of being filled while a yellow may indicate that one bin, i.e., 32 or 34, is full of accepted tags.

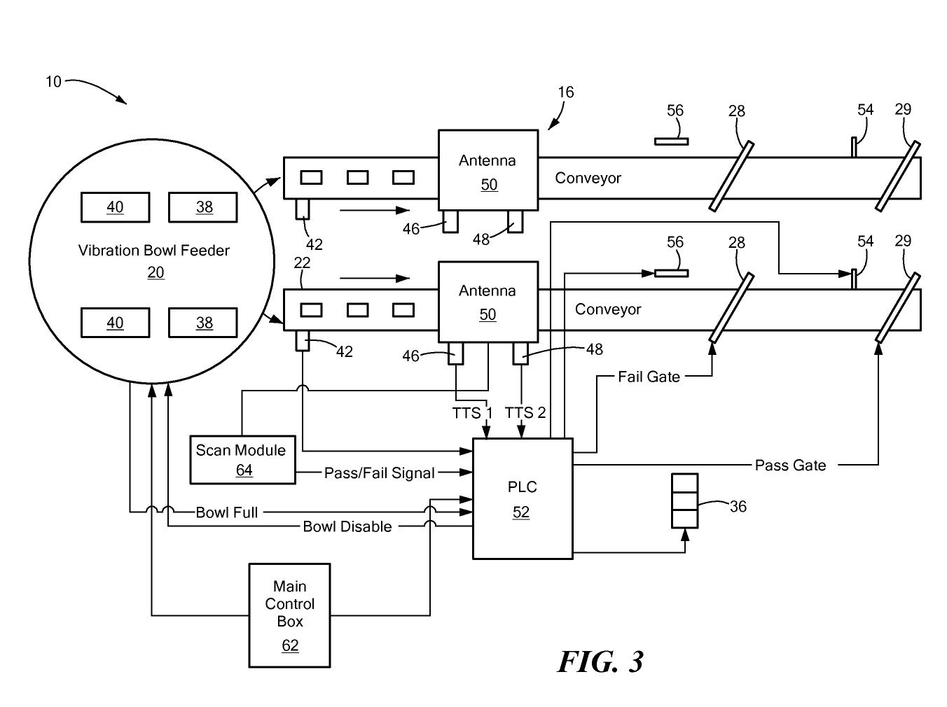

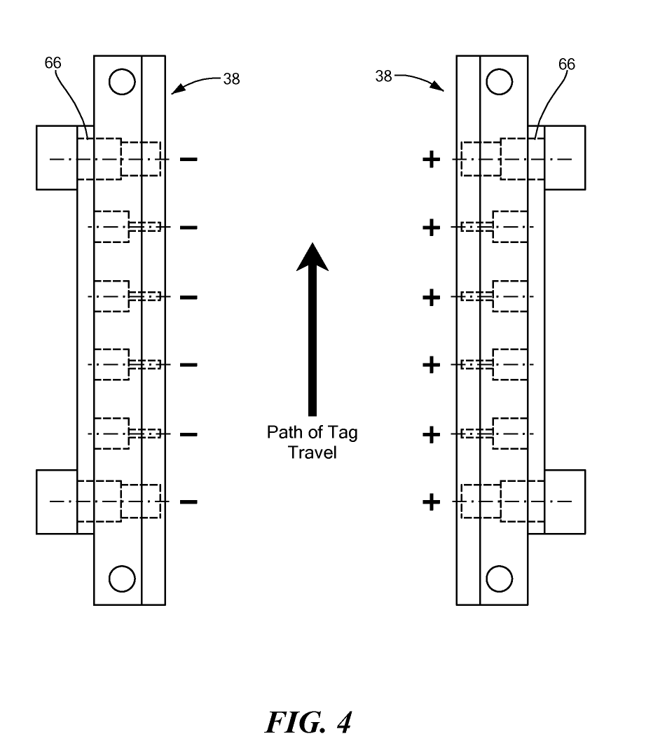

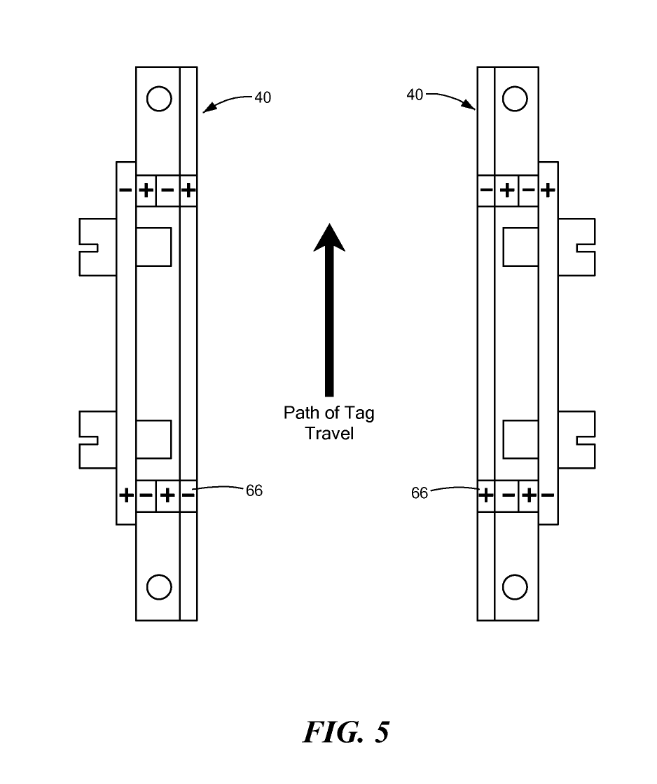

FIG. 3 is a block diagram of system 10. Included in vibratory bowl 20 are one or more demagnetizers 40 and magnetizers 38. The arrangement of demagnetizers 40 and magnetizers 38 are discussed in greater detail below with respect to FIGS. 4 and 5. Demagnetizers 40 and magnetizers 38 initialize VSTs by re-activating pre-used VSTs so that the VSTs may be reused. This is accomplished by applying a magnetic field, via demagnetizers 40 and magnetizers 38, to the acousto-magnetic component of the VST. One or more conveyors 22 receive tags after they have been demagnetized and magnetized in vibratory bowl 20. Vibratory bowl 20 performs a mechanical sort of the VSTs, differentiating VST tags having specified dimensions as potentially reusable VSTs while discarding those that do not meet the required mechanical dimensions. Tags considered reusable exit vibratory bowl 20 and are fed into conveyor 22 until they approach testing subsystem 16, which tests each tag to determine if they are operable and can be reused. FIG. 3 illustrates the use of two separate conveyors 22, each carrying potentially reusable tags to a respective testing subsystem 16. It is within the scope of the invention to use any number of conveyors 22, including only a single conveyor 22 and corresponding testing subsystems 16.

Various sensors are disposed throughout system 10. A first sensor 42, which may be a Sourcing Tag Sensor (“STS”) is a sourcing tag sensor that determines if tags passing along conveyor 22 are ready to be released for testing by testing subsystem 16. Sensors 46 and 48 are input sensors that detect the presence of tags on conveyor 22 within the signal transmission test window of one or more antennas 50. Antennas 50 can be, for example, compact, high inductance antennas that both detect and measure tag parameters to determine if the tag is acceptable for reuse. The sensors described herein may be any type of sensing device including optical sensors.

Antenna 50 transmits an interrogation signal to a tag and receives a response signal which is sent to scan module 64, which determines if a VST is within a predetermined frequency range, e.g., 58 KHz+/−600 Hz and within a minimum predetermined amplitude, e.g., 0.5 nWb. If scan module 64 determines that the VST being evaluated falls within the predetermined parameters, scan module 64 sends a pass signal to a Programmable Logic Controller (“PLC”) 52 which establishes that the VST will be directed toward accept bins 32 and 34. If scan module 64 determines that the VST being evaluated does not fall within the predetermined parameters, scan module 64 sends a fail signal to a Programmable Logic Controller (“PLC”) 52 which establishes that the VST will be directed toward reject bin 30.

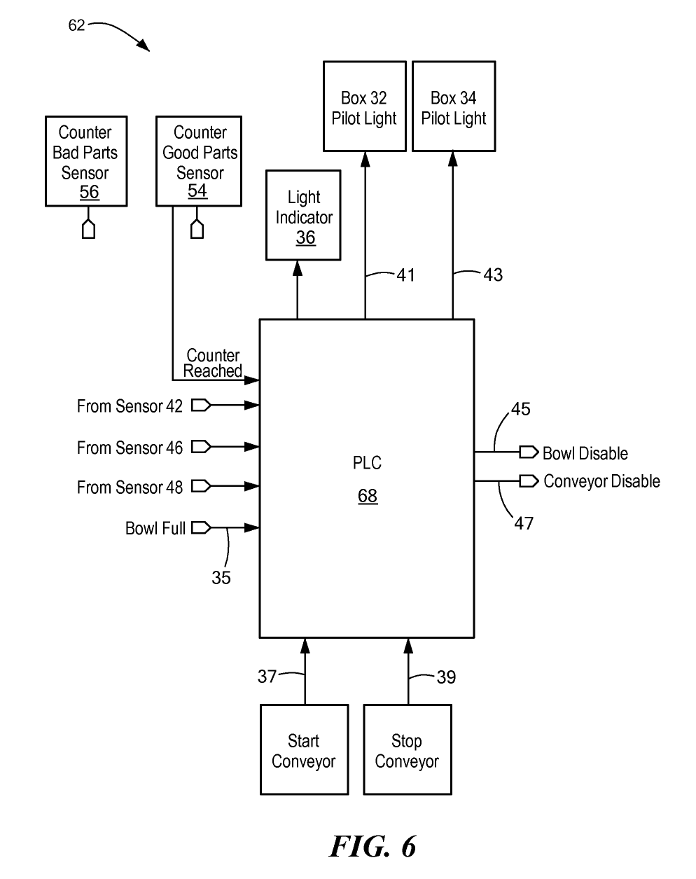

Sensors 54 count the number of tags that have been accepted and sensors 56 count the number of tags that are rejected. Pass gate 29 directs accepted tags into accept bins 32 and 34 while fail gate 28 directs tags that do not pass testing toward reject bin 30. Main control box 62 coordinates each of the functions of system 10 by providing control signals to various components of system 10 including PLC 52. The components of main control box 62 are discussed in greater detail below with respect to FIG. 6.

Scanning module 64 receives signals from antennas 50 and scanning module 64 determines if the VST being tested by antenna 50 falls within the acceptable frequency range. A pass/fail signal is sent from scanning module 64 to PLC 52, which determines if the tested VST will be sent to one of the accept bins 32, 34 or reject bin 30. Of note, although the present invention is described with reference to two accept bins and one reject bin, the invention is not limited to such. Any number of fail gates 28 and pass gates 29 can be used to direct VSTs to corresponding accept and reject bins.

Once reusable VSTs are separated from disposable VSTs within vibratory bowl 20, a series of demagnetizers and magnetizers deactivate and reactivate each VST so that they may be tested to assure their functionality. FIG. 4 illustrates an exemplary pair of magnetizer elements 38 used in vibratory bowl 20 of feeder subsystem 12. Each magnetizer element 38 includes a series of magnets 66 oriented as shown in FIG. 4. As seen in the embodiment of FIG. 4, magnets 66 of each magnetizer element 38 are arranged such that the negative polarities of one magnetizer element 38 face the positive polarities of the magnets 66 in the opposite magnetizer element 38. Although magnetizer element 38 depicted in FIG. 4 each contain six magnets 66, the invention is not limited to a specific number of magnets 66 in each magnetizer element 38.

FIG. 5 illustrates two demagnetizer elements 40, each containing a series of magnets 66 in the orientation shown in FIG. 5. The arrangement of magnets 66 in the embodiment shown in FIG. 5 is exemplary, and the invention contemplates the user of more or less magnets 66 as well as other magnet arrangements. Thus, once a VST is determined to be reusable, it is passed between demagnetizer elements 40 and deactivated via magnets 66. The VST is then passed between magnetizer elements 38 and then re-activated via magnets 66. This process serves to erase any information that may have been stored on the VSTs during their previous use and re-initiates the VSTs for future use.

FIG. 6 is a block diagram illustrating an exemplary embodiment of the components and interactions of main control box 62. Main control box 62 includes PLC 68. PLC 68 provides control signals to its corresponding conveyor belt 22, sensors and light indicators to perform the functions described herein. For example, PLC 68 receives signals from STS sensor 42, indicating if tags passing along conveyor 22 are ready to be released for testing by testing subsystem 16, and from sensors 46 and 48 indicating the presence of tags on conveyor 22 within the signal transmission test window of one or more antennas 50. PLC 68 also receives other signal indicators such as a signal 35 from vibratory bowl 20 indicating that vibratory bowl 20 is full and cannot receive more VSTs until the VSTs in the bowl are processed. PLC 68 also receives communications from counter sensor 54, which indicates how many VSTs have been accepted by testing subsystem 16, and from counter sensor 56, which indicates how many VSTs have failed testing. Other signals that may be received by PLC 68 include conveyor start/stop signals 37 and 39 that instruct PLC 68 to start or stop conveyor 22 upon which the VSTs are carried, as needed.

PLC 68 can also provide output signals to various components of system 10. For example, PLC 68 can provide signals to light indicator 36, indicating the status of system components. PLC 68 can also transmit signals 41 and 43 to pilot light devices that indicate when boxes, e.g. boxes 32 or 34, containing tested VSTs are full and need to be replaced. Other output signals may include a bowl disable signal 45 that temporarily disables the function of vibratory bowl 20 in response to a received “bowl full” signal, and a conveyor disable signal 47 which disables conveyor 22 when for example, some malfunction occurs in conveyor 22.

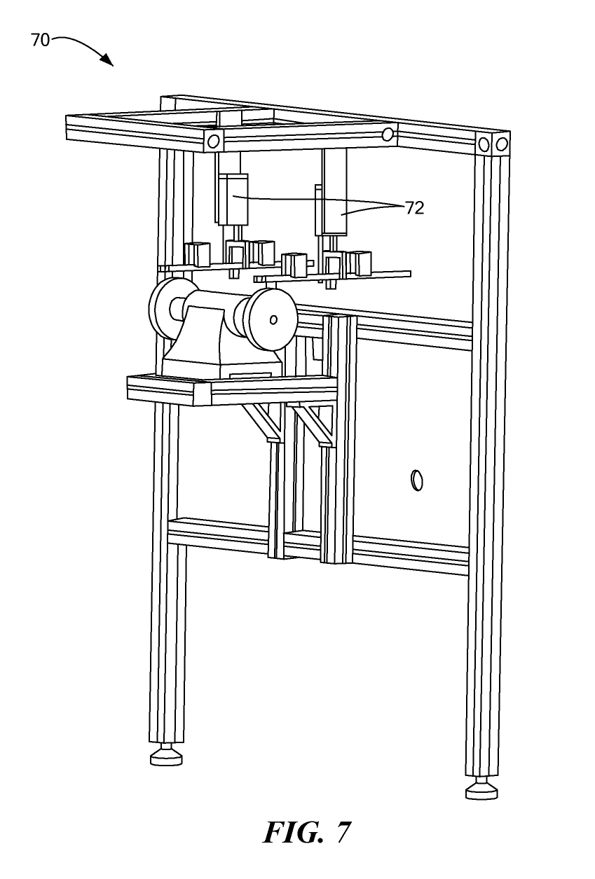

FIG. 7 is a perspective view of a rail assembly 70 used in sorting subsystem 14. Rail assembly unit 70 is situated at the beginning of conveyors 22. Rail assembly 70 can be adjusted to situate the tags 22-24 inches apart from each other along conveyor 22. Rail assembly 70 receives VSTs from vibratory bowl 20 that were not discarded, i.e., VSTs that are reusable tags and places these VSTs, one at a time, on conveyors 22 at a set speed until that speed is altered. For example, rail assembly 70 can release a VST, one to each conveyor 22, every 0.8 seconds. Thus, rail assembly 70 assures the space and timing between VSTs for appropriate detection by testing subsystem 16. Alignment assembly 72 properly aligns each VST as the VST travels along conveyor 22 toward testing subsystem 16. Alignment assembly 72 assures each VST is correctly aligned as the VST enters the testing window of antenna 50.

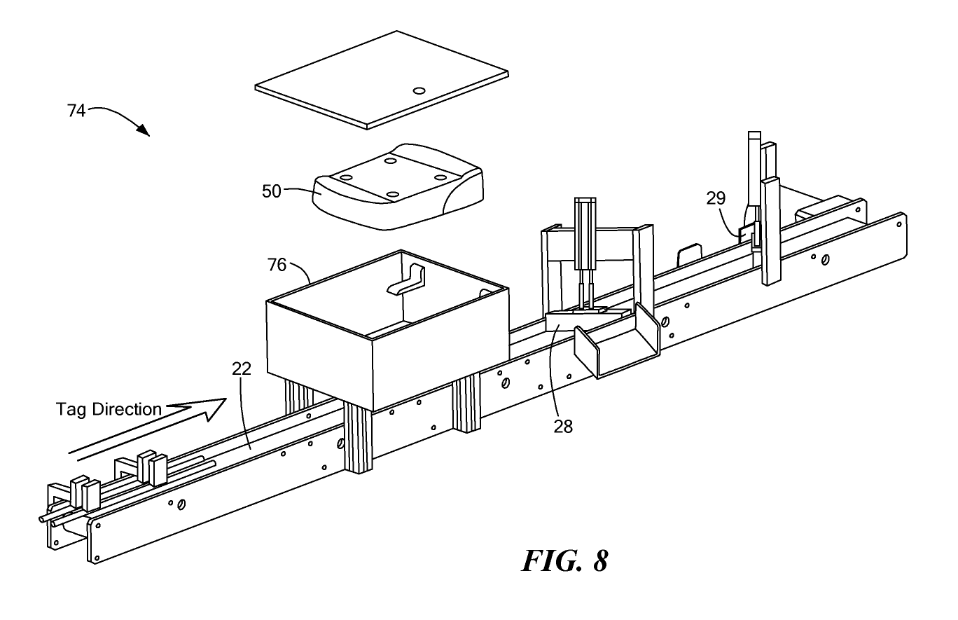

FIG. 8 shows the components of the conveyor and antenna assembly 74 of testing subsystem 16. As VSTs travel along conveyor 22, they travel under antenna 50, which is supported and enclosed by an antenna enclosure 76. In one embodiment, antenna enclosure 76 is positioned 3 inches above conveyor 22 that is transporting the VSTs. Antenna enclosure 76 includes a window opening that allows antenna 50 to transmit test signals to VSTs through the window as the VSTs pass along conveyor 22 beneath antenna 50. In one embodiment, the window is 3 inches by 5 inches although the window dimensions of antenna enclosure 76 can vary depending upon design constraints. The window opening limits interrogation field dispersion as well as limits the received response signal to the intended subject (VST) of interrogation. As discussed above, sensors 46 and 48 along with PLC 52 determine where the tested VSTs are routed, e.g., toward fail gate 28 and reject bin 30 or pass gate 29 and accept bins 32 and 34.

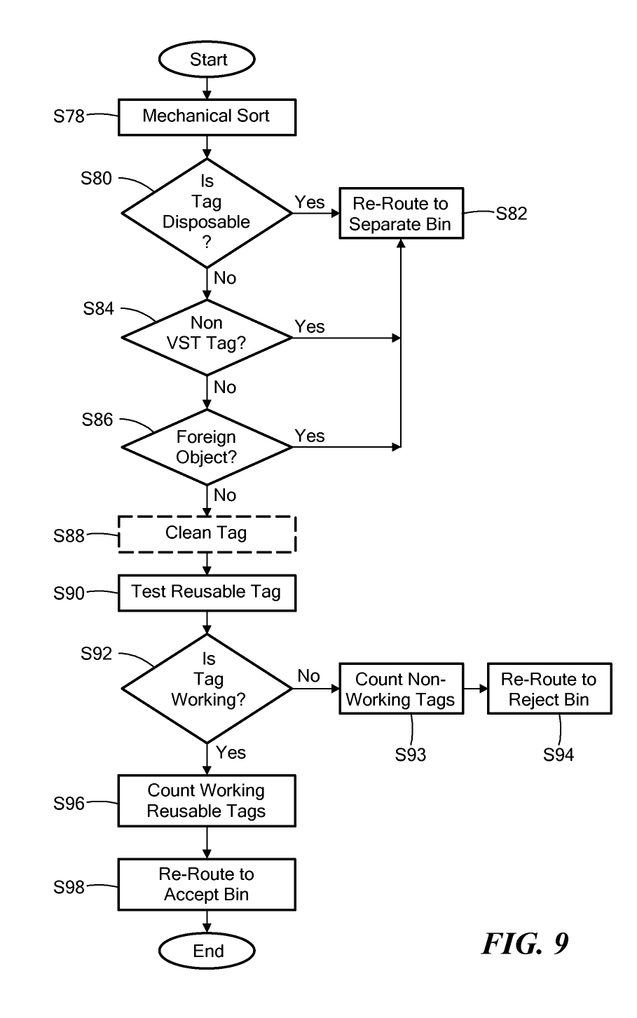

FIG. 9 is a flowchart illustrating an exemplary VST sorting and testing process 10 of the present invention. Initially, the tags are passed on from feeder subsystem 12 to sorting subsystem 14 where they are subject to a mechanical sort. The VSTs are separated within vibratory bowl 20 into two categories, tags that are reusable or tags that are not reusable (step S78). If it is determined that the tag is found to be disposable and not reusable (step S80) the tag is routed to a separate bin (step S82). If, during the mechanical sort, it is determined that the tag is a VST single use tag (step S84) it is also routed to a separate bin (step S82) where it could be discarded, if desired. If a foreign object is found during the mechanical sort (step S86), then the foreign object can be routed to a bin (or remain in vibratory bowl 20) and disposed of (step S82).

Once it is determine that the object being tested is a VST, the VST tag may be cleaned (step S88) if desired and passed on to testing subsystem 16, where the VST is tested (step S90). If the VST does not pass testing (step S92) by falling outside the range of required frequency and/or amplitude parameters, it is counted as a non-working tag (step S93) and re-routed to a reject bin (step S94). If the VST passes the testing procedure it is counted as a working reusable tag (step S96) and re-routed to an accept bin (step S98).

The present invention can be realized in hardware, software, or a combination of hardware and software. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form.

In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

What is claimed is:

1. A system for testing reusable electronic article surveillance (EAS) tags, the system comprising:
a feeder for receiving previously used EAS tags;
a sorter receiving the previously used EAS tags from the feeder, the sorter determining if the previously used EAS tags are reusable tags; and
a testing station receiving the reusable EAS tags from the sorter, the testing station determining if the reusable EAS tags are functioning within predetermined operational parameters.

2. The system of claim 1, wherein the feeder includes at least one magnetizer element and at least one demagnetizer element for activating the previously used EAS tags.

3. The system of claim 1, further comprising at least one sensor, the at least one sensor counting each reusable EAS tag that is functioning within predetermined operational parameters.

4. The system of claim 1, wherein the testing station includes at least one antenna for transmitting test signals to the reusable EAS tags, the at least one antenna receiving responsive signals from the reusable EAS tags, the responsive signals used to determine whether the reusable EAS tags are functioning within predetermined operational parameters.

5. The system of claim 4, wherein the testing station includes a processor, the processor receiving, from the at least one antenna a communication related to the responsive signals, the processor determining if the reusable EAS tags are functioning within predetermined operational parameters based on whether the responsive signals are within a predetermined frequency range and within a predetermined minimum amplitude.

6. The system of claim 1, further comprising at least one conveyor providing a tag transportation path from the sorter to the testing station.

7. The system of claim 6, further comprising at least one sensor, the at least one sensor determining the presence or absence of EAS tags along the at least one conveyor.

8. A method for testing reusable electronic article surveillance (EAS) tags, the method comprising:
separating, at a sorter, reusable EAS tags from disposable EAS tags;
using a demagnetizer and magnetizer to re-activate reusable EAS tags; and
automatically determining if the reusable EAS tags are functioning within predetermined operational parameters.

9. The method of claim 8, wherein automatically determining if the reusable EAS tags are functioning within predetermined operational parameters is based on whether the responsive signals are within a predetermined frequency range and within a predetermined minimum amplitude.

10. The method of claim 8, further comprising transporting the reusable EAS tags to the testing station via a conveyor system, the testing station automatically determining if the reusable EAS tags are functioning within predetermined operational parameters.

11. The method of claim 8, further comprising counting the EAS tags that are functioning within predetermined operational parameters.

12. The method of claim 8, wherein automatically determining whether the reusable tags are functioning within predetermined operational parameters includes:
transmitting test signals to the reusable EAS tags;
receiving responsive signals from the reusable EAS tags; and
comparing the responsive signals to the at least one predetermined operational parameter.

13. The method of claim 8, further comprising automatically cleaning the reusable EAS tags.

14. The method of claim 8, further comprising automatically separating reusable EAS tags that are functioning within predetermined operational parameters from those reusable EAS tags that are not functioning within predetermined operational parameters.

15. The method of claim 14, wherein automatically separating reusable EAS tags that are functioning within predetermined operational parameters from those reusable EAS tags that are not functioning within predetermined operational parameters includes actuating one of a pass gate and a fail gate to divert respective reusable EAS tags that are functioning within predetermined operational parameters from those reusable EAS tags are not functioning within predetermined operational parameters.

16. An automated system for determining the presence of operable, reusable electronic article surveillance (EAS) tags from among used EAS tags, the system comprising:
a feeder for receiving previously used EAS tags;
a sorter receiving the previously used EAS tags from the feeder, the sorter determining if the previously used EAS tags are reusable tags, the sorter including at least one magnetizer element and at least one demagnetizer element for activating the reusable EAS tags;
a testing station comprising at least one antenna for receiving responsive signals from the reusable EAS tags, the responsive signals being used to determine if the reusable EAS tags are functioning within predetermined operational parameters; and
a conveyor system for spacing the reusable tags and transporting the spaced reusable tags from the sorter to the testing station.

17. The system of claim 16, further comprising a cleaning station disposed along the conveyer system.

18. The system of claim 16, further comprising at least one sensor disposed along the conveyor system, the at least one sensor determining the presence or absence of EAS tags along the conveyor system.

19. The system of claim 16, further comprising at least one counting sensor, the at least one sensor counting each reusable EAS tag that is functioning within predetermined operational parameters.

20. The system of claim 16, wherein the testing station includes a processor, the processor receiving, from the at least one antenna, communication related to the responsive signals, the computer determining if the reusable EAS tags are functioning within predetermined operational parameters.
